(19) United States
(12) Patent Application Publication
(10) Pub. No.: US 2008/0041940 A1
(43) Pub. Date: Feb. 21, 2008

(54) Pocket data, medical record and payment device

(76) Inventor: Walter L. Weeks, Marietta, GA (US)

Correspondence Address: Walter L. Weeks, 2445 Alexander Lake Drive SW, Marietta, GA, 30064, US

(21) Appl. No.: 11/810,118

(22) Filed: Jun. 4, 2007

Related U.S. Application Data
(60) Provisional application No. 60/811,466, filed on Jun. 7, 2006.

(51) Int. Cl. G06K 5/00

(52) U.S. Cl. 235/380

(57) ABSTRACT

The invention is a unique system that allows a person to carry their medical information with them at all times. It makes medical information rapidly available during emergency situations, resulting in better care and more lives saved. The invention integrates with a credit or debit card for easy billing.

### RELATED U.S. APPLICATION DATA

The present application claims priority to U.S. Provisional Application No. 60/811,466 filed Jun. 7, 2006, said prior applications being incorporated herein by reference in their entirety.

### FIELD OF THE INVENTION

This invention relates to the recording of personal data such as medical records and information, specifically it is an adhesive or integrated contact or contact less smart cards attached/integrated with/to a USB flash memory or “jump” drive that is the size of a credit card but slightly thicker and incorporates a Smart Card as well as possibly Drivers License information as well as a Photograph that allows a person to carry their data such as but not limited to medical records and payment information with them at all times. A hole in the card allows it to be worn on a necklace like military “dog tags”.

This invention relates to the field of Military and public health and public safety, specifically a device that would allow emergency workers to read medical information from the USB interface or smart card interface in the event of a medical emergency.

This invention relates to the field of payment methods, specifically a smart card affixed to the USB card that would allow easy payment from multiple sources such as but not limited to Credit Cards, Debit Cards, Medical Savings Accounts, Insurance Payment Accounts, Medicare and Medicaid accounts, Food Stamp Programs or other Entitlement programs when/where smart card reading devices are available.

### BACKGROUND OF THE INVENTION

Currently, many medical records are still stored in physical form, made up of paper charts, graphs, x-ray films, and other information contained in a large file folder. Medical records that are stored in electronic form are often kept in a networked database, retrievable via a high-speed internet connection. In almost no cases are medical records stored in the hands of the patient. This produces challenges for rapid information retrieval, especially during cases when emergency medical care is necessary. Emergency medical workers also lack the ability to retrieve patient medical information on site. Emergency workers could save lives if they had immediate access to medical information. For instance, knowing whether or not a patient is allergic to iodine, a common ingredient in IVs could mean the difference between life and death.

### OBJECTS OF THE INVENTION

It is an object of the invention to provide the convenience of carrying medical data, insurance information, and payment information at all times in ones wallet.

It is an object of the invention to allow emergency personnel access to information stored in the invention that is stored in the public area, the private encrypted area will not be visible to anyone without the de-crypting password used to encrypt this private information.

It is an object of the invention to contain data on a credit card-sized USB flash drive combined with a smart card. The smart card stores payment or insurance information, and the USB flash drive contains enough memory to store the entire medical record or enough of the medical record to be useful. The card is small enough to ride easily in a person's wallet or around the neck on a necklace.

Conventional USB flash drives (see FIG. 1.2) are thicker, and can be stored on a keychain or in one's pockets. Because of their size and shape, they are easily lost. The credit-card sized USB drive and smart card will easily fit into a wallet (see FIG. 1.3). Most people take great care to protect their wallets, so the pocket medical record would be more secure than if it was contained on a regular USB flash drive.

It is an object of the invention to us a credit card-sized USB drive that contains a collapsible or rigid USB jack that allows information to be read from the card into a computer or other digital device. Unlike most USB jacks, the jack on the USB drive can be inserted in any direction. This will save time when medical workers must retrieve information during an emergency situation.

It is an object of the invention to store portions of or the entire medical record in encrypted form to protect sensitive information. Certain basic information is not encrypted and is easily readable by emergency medical workers. The rest of the information is encrypted to preserve privacy and comply with HIPAA standards.

It is an object of the invention to integrate a contact less or contact based Smart Card as a credit card, debit card, Medicare Payment Card, or Medical Savings Account Card and is integrated or attached to one surface of the smart card to allow payment information and medical information to be contained in one unit.

### BRIEF DESCRIPTION OF THE DRAWINGS

FIG. 1 shows the process of loading information onto the invention.

FIG. 2 shows how a patient can carry the invention with them at all times.

FIG. 3 shows how a patient will present the invention at the doctor's office.

FIG. 4 shows how the doctor's staff manipulates the information from the invention.

FIG. 5 shows how the patient can use the invention to pay for services rendered at the doctor's office.

FIG. 6 shows how the invention would work in the event of a medical emergency such as an automobile accident.

FIG. 7 shows the Walletex Flash Drive with USB jack next to a standard business card to show its size. The Walletex Flash Drive easily fits in one's wallet.

FIG. 8 shows a standard USB Flash Drive. Note how the shape is much different than the Walletex. Standard USB drives are easily lost.

FIG. 9 shows how the Walletex easily fits into a wallet.

FIG. 10 shows a contact smart card, complete with chip that must make physical contact with a reader for it to function.

FIG. 11 shows the details of a contact smart card, the card body, and the imbedded chip.

FIG. 12 shows a contact less smart card. Note the absence of a visible chip.

FIG. 13 shows details of a contact less smart card. Note how the chip sits in the interior of the card, and is surrounded by an antenna.

FIG. 14 shows “Medical Records” imprinted on edge of card for easy identification by Emergency Workers.

### DETAILED DESCRIPTION OF THE INVENTION

Implementation of the invention requires hardware and software. The card requires a combination of a Walletex USB flash drive with a contact-less smart card. The smart card handles payment in the form of debit or credit. The USB flash drive contains medical information, including the patient's medical history, common medicinal allergies, and any other information the patient and the patient's physician agree to include. The invention also uses encryption implemented in software to protect sensitive medical information from theft or disclosure. Less sensitive and potentially life-saving information such as medicinal allergies would remain unencrypted so emergency medical works will have access.

The invention also requires deployment of hardware and software to medical offices, hospitals, and emergency workers. Medical offices and hospitals are almost always equipped with computers capable of reading standard USB drives. However, they may need to purchase hardware to read smart cards in order to process payments. Emergency medical workers will also need equipment, such as PDAs or smart phones, to read the USB flash drives at the scene of an accident.

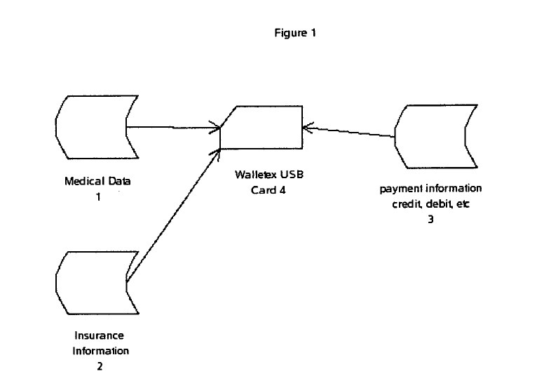

Turning now to the figures, FIG. 1 displays the data which can be loaded onto the invention. Medical data 1 comprising charts, notes, histories, allergies, X-ray images, lab results, or other kinds of data maybe loaded onto the USB flash drive 4. The patient and their primary care physician may agree upon which kinds of information should be loaded onto the card. Insurance 2 and 3 payment information may also reside on the card 4.

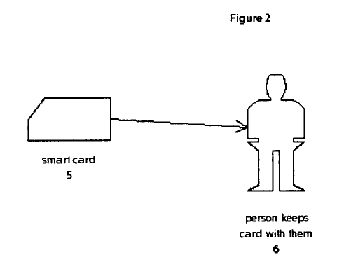

FIG. 2 describes how the patient 6 can carry the invention 5 with them at all times. The USB drive and smart card combination are small enough to fit into most any wallet and purse. Thus patients can have their medical information with them at all times, giving them total control over their files, as well as keeping their medical information close by in the event of an emergency.

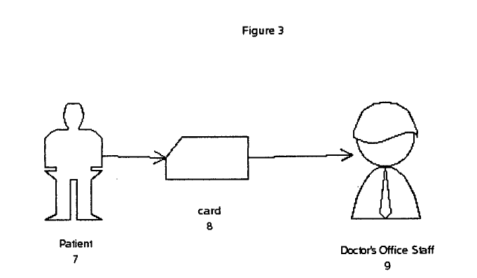

FIG. 3 shows use of the invention at a doctor's office. The patient 7 enters the office and presents the invention 8 to the desk staff 9.

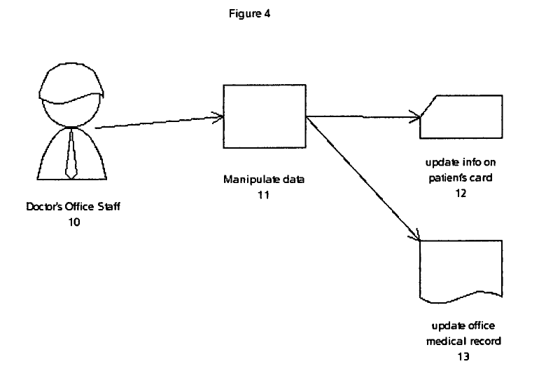

FIG. 4 shows how the desk staff uses the invention. The front desk clerk 10 plugs the USB drive into their computer and brings up the data. They can manipulate the data 11 just like he would with any normal windows file system. Next, they may update information on the patient's card 12 as well as updating their own copy 13 of the patient's file.

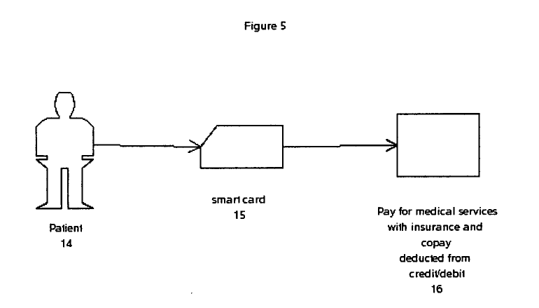

In FIG. 5, the patient 14 uses the smart card 15 component of the invention to pay for medical services rendered using either credit or debit 16. The USB portion contains insurance information, so the patient may only be billed for the co-payment, which is easily charged to credit or deducted via debit from their account. For example, the co-payment can be paid by debit card, while a vaccination may be paid for by Medicare. Elective procedures may be paid for via a medical savings account, and any remaining balance for elective or required procedures may be paid for by secondary or supplemental insurance.

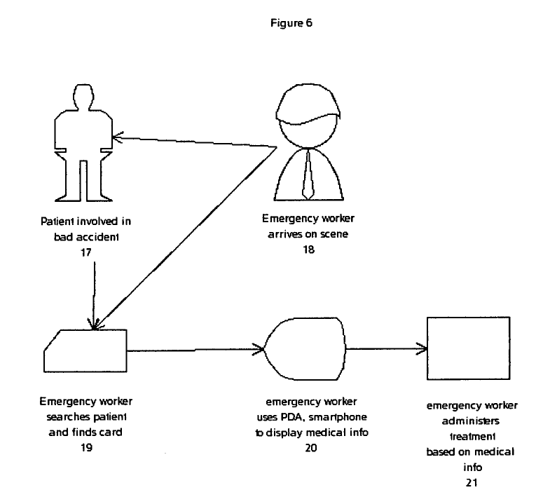

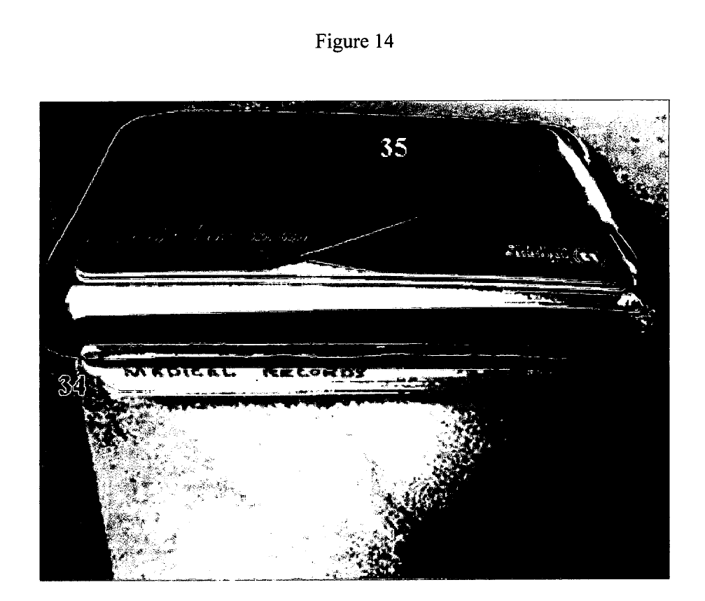

FIG. 6 displays the invention's use during a medical emergency, such as an automobile accident. The patient 17 receives injuries during an automobile accident and is incapacitated. Emergency medical workers 18 arrive on the scene and search the patient for the invention 19. The text “MEDICAL RECORD” is visible on the edge of the card (See FIG. 14). The emergency worker then uses their device, such as a smart phone, PDA, or laptop computer to access information from the invention 20. The emergency workers then administer higher-quality treatment once they have access to the patient's medical history 21.

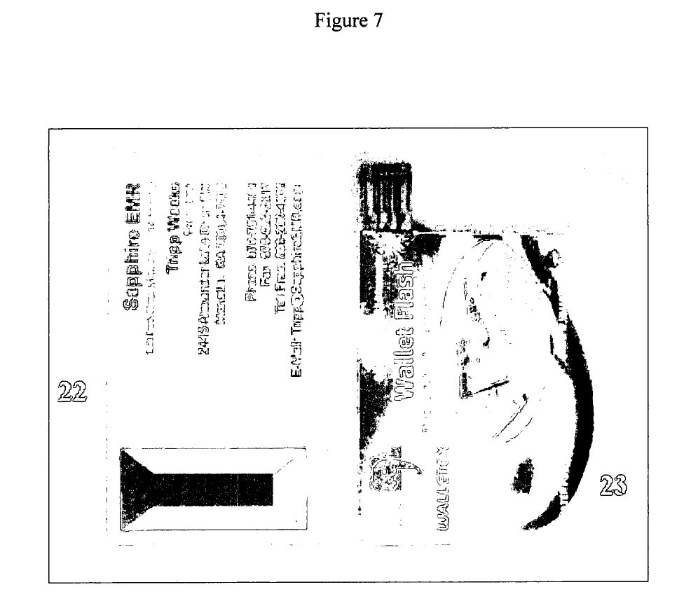

FIG. 7 compares a business card 22 to a Walletex USB flash drive 23. They are roughly the same size.

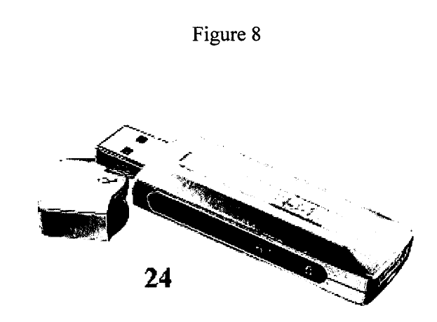

FIG. 8 shows a normal USB flash drive 24. Note its different shape. These devices are widely used to store personal data, yet are easily misplaced or stolen. Most people do not carry them around at all times, unlike a wallet or purse.

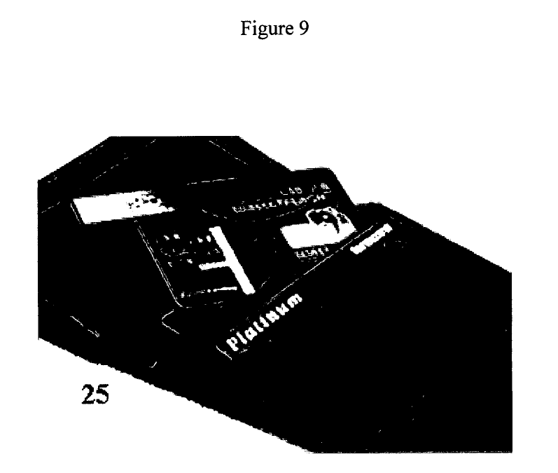

FIG. 9 shows how a Walletex USB flash drive fits into a standard wallet 25. This allows a person to keep the flash drive with them at all times, much as they would their driver's license or credit card.

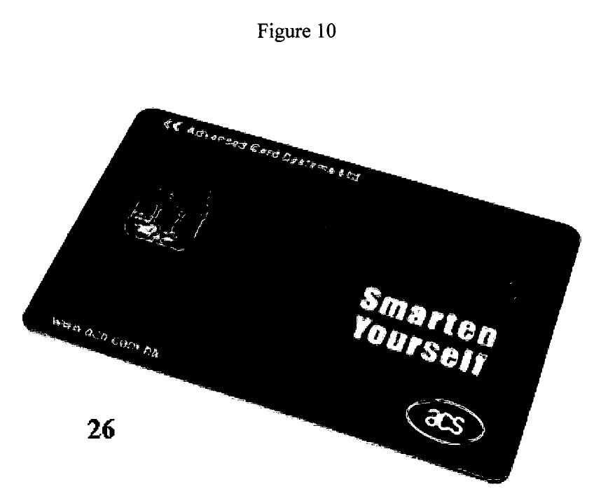

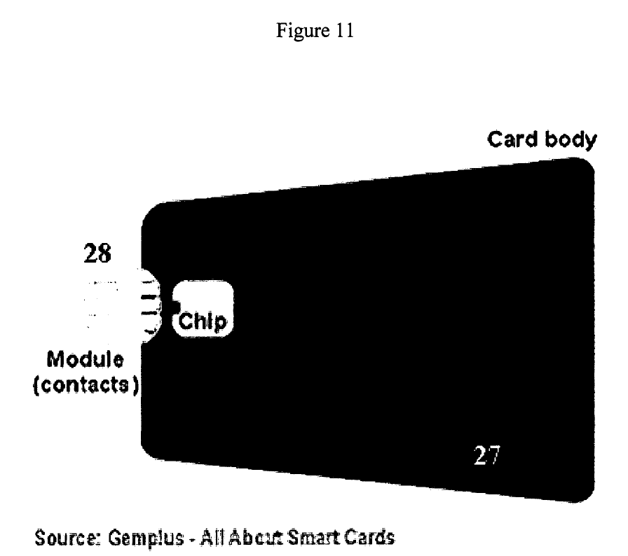

FIG. 10 shows a contact-based smart card 26. This card may contain payment information, such as debit or credit card numbers. FIG. 11 shows the details of a contact-based smart card 27. The contact-based smart card is usually inserted into a slot where the onboard chip 28 is read by a machine.

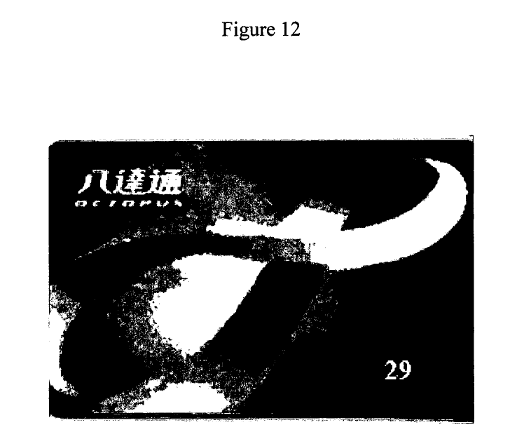

FIG. 12 shows a contact-less smart card 29, which is the preferred embodiment of this invention. The contact-less design allows a reader to access the card by merely being within close proximity to the reader. It does not need to be inserted into a machine, this is preferred because once the Walletex USB flash drive is attached, a contact-based card may not fit into the reader.

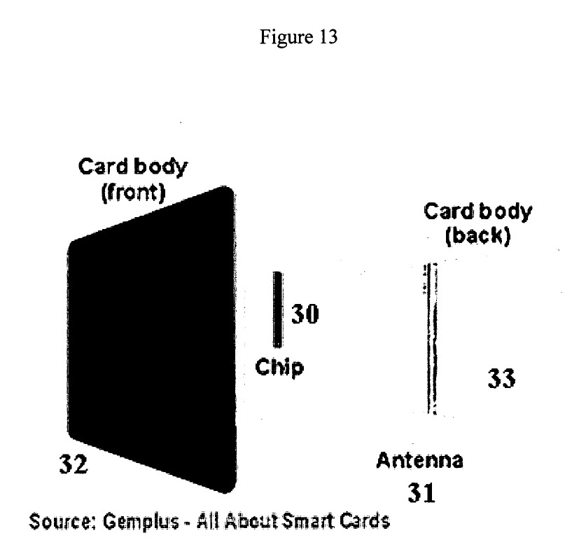

FIG. 13 shows the inner workings of a contact-less smart card. A chip 30 and antenna 31 are sandwiched between the front 32 and back 33 of the card body. The chip 30 stores information in the same manner as a contact-based card. However, the antenna 31 allows the card to be read by proximity, without being in direct contact with a reader.

FIG. 14 shows the invention 34 stored in a typical wallet 35. Note the text “Medical Records” written on the card 34, which is easily visible to anyone looking in the wallet. Thus emergency medical personnel should be able to find a patient's records easily and quickly.

I claim:

1. A system of capturing and storing personal data, patient medical records and medical insurance and payment information comprising:
a) providing a credit card-sized USB flash drive or similar device to store said patient medical records combined with a Smart Card or similar device to store said payment information including medical insurance and payment information such that said USB flash drive and Smart Card combination easily fits into one's wallet or worn on a necklace,
b) providing a USB jack and a means for emergency medical workers, hospital workers, and other health and medical workers to view and change said patient medical records,
c) providing a Smart Card and a means for health and medical workers to process said medical insurance and payment information,
whereby said system will allow an individual to contain said patient medical record and said medical insurance and payment information in one small credit card-sized unit.

2. The credit card-sized USB flash drive or other device of claim 1 providing a mechanism for encrypting patient data such that it may only be viewed when a pass phrase, pin number, or similar phrase is entered by the owner via keyboard. Biometric information may also become available once Card development allows for this feature.
